(19) United States
(12) Patent Application Publication
(10) Pub. No.: US 2010/0281169 A1
(43) Pub. Date: Nov. 4, 2010

(54) PRESENCE-AWARENESS FOR WIRELESS DEVICES

(75) Inventor: John Charles, Blackburn (AU)

Correspondence Address: OSHA LIANG L.L.P., TWO HOUSTON CENTER, 909 FANNIN, SUITE 3500, HOUSTON, TX, 77010, US

(73) Assignee: AIRSCAPE TECHNOLOGY PTY. LIMITED, Sydney, New South Wales (AU)

(21) Appl. No.: 12/738,622

(22) PCT Filed: Oct. 20, 2008
(86) PCT No.: PCT/AU08/01548

§ 371 Date: Jul. 12, 2010

(30) Foreign Application Priority Data
Oct. 19, 2007 (AU) 2007905746

(51) Int. Cl. G06F 15/16; H04W 4/00; G06F 17/00

(52) U.S. Cl. 709/227

(57) ABSTRACT

The invention relates to computer software product (11) adapted for execution on a wireless device (10) in communication with a carrier network (15). The software product includes instructions for establishing a data channel (24) with an Internet-based server (16) independently of the carrier network and for maintaining the channel in an open state. It is the channel itself that indicates presence of the wireless device in a presence-aware application, such as an email client, instant messaging client or business application. The invention also relates to a computer software product adapted for execution on the server (16) that manages the data channels (24) and facilitates communication between the presence aware application (17) and wireless device (10).

### FIELD OF THE INVENTION

The present invention relates to presence-aware applications. In particular, the present invention relates to implementing presence-aware applications on wireless devices.

### BACKGROUND OF THE INVENTION

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

A ‘presence-aware application’ signifies an application with knowledge of one or more characteristics of devices communicating with the application, or of the users of those devices. Instant messaging and social-networking sites are typical presence-aware applications, having knowledge of the network status of participants, in the sense of whether participants are logged into the application or site.

Presence-awareness is also increasingly being built into business applications, such as Customer Relationship Management and conferencing systems, in order to enhance and facilitate mainstream business functions.

In some cases, presence-awareness is required in order to provide ‘push’ functionality—in which content is automatically delivered to a device without being specifically requested. Push applications need to have some knowledge of the status of devices to which content is delivered, before attempting to deliver the content. Again, instant-messaging is a typical example of such functionality, as instant messages are automatically displayed on recipients' devices when the devices are logged in. Push-email (such as that implemented on Blackberry® and similar wireless devices), online share-trading systems, news services and auction-alert systems are further examples.

Instant messaging and other presence-aware applications have been deployed on wireless devices, where the device accesses the Internet via a wireless network, such as the mobile (or cellular) telephone networks operated by the telecommunications carriers.

U.S. Pat. No. 7,020,480 is an example of such a system, describing an architecture for an instant messaging service for wireless devices. The relevant carrier network is a GSM/GPRS network that includes a conventional Base Station Controller and Mobile Switching Centre. Access to the Internet from the carrier network is enabled by a GPRS Support. Node, that connects the Base Station Controller, via a gateway, to the carrier's internal IP network, which is in turn connected to the public Internet.

Presence information of wireless devices connected to the carrier network is detected by a Presence Server by utilising the infrastructure of the carrier network described above. In particular, the Presence Server monitors changes in a device's record in a Home Location Register, which, as will be understood by those skilled in the art, is accessible to the GPRS Support Node.

Another proposal for wireless instant messaging is described in technical documents produced by the Open Mobile Alliance (http://www.openmobilealliance.org/). The architecture described in the documents includes a Wireless Village Server, which provides similar functionality to the Presence Server of U.S. Pat. No. 7,020,480, in accessing the carrier network infrastructure to obtain presence information of the wireless devices connected to that network.

The communication of presence information to and from wireless devices is discussed elsewhere in the patent literature. For example, published US Patent Application No. 2005/0086376 describes a protocol for synchronising presence attribute data (such as friend list information) between a terminal or mobile device and a server. Presence attribute data is initially synchronised between the terminal and server when two are connected to establish a messenger service between them. Upon subsequent connections of the terminal to the server, only presence attribute data created after the time of an earlier connection are forwarded to the terminal.

U.S. Pat. No. 7,187,935 focuses on creating a presence profile of a mobile device over time, and does so by correlating an observed presence profile with a set of model presence profiles. The model profile that best correlates with the observed profile is selected as a current presence profile for the mobile device.

Published US Patent Application No. 2007/0130260 A1 describes a method for buddy list presence detections and status synchronisation between PSTNNOIP telephones and wireless devices via a server-side presence server.

The present invention aims to provide an improved or alternative method and system to implement presence-aware applications on wireless devices to those described above.

### SUMMARY OF THE INVENTION

According to a first aspect of the present invention there is provided a computer software product adapted for execution on a wireless device in communication with a carrier network, the software product comprising:
instructions for establishing a data channel with an Internet-based server independently of the carrier network; and
instructions for maintaining the channel in an open state, wherein the channel indicates presence in a presence-aware application.

The present invention takes a different approach to the communication of presence information from a wireless device, by not relying on services or infrastructure provided by the underlying carrier network used by the wireless device to access the Internet. Instead, the device establishes and maintains a data channel (such as an TCP/IP socket connection) with an Internet-based server. It is the existence of the channel that indicates presence of the wireless device (or of the software product), in a presence-aware application.

In doing so, the present invention enables presence-aware applications (including instant-messaging and business applications) to be rapidly developed for wireless devices, owing to the fact that such applications no longer require knowledge of, nor direct access to, the internal workings of the carrier networks used by wireless devices to access the Internet.

In addition, the carder-independent nature of the present invention enables development of far more scalable presence-aware applications in comparison to solutions that rely on access to the carrier network services and infrastructure to obtain presence information.

Preferably, the data channel is configured to enable event notification messages associated with the presence-aware applications to be delivered to the wireless device. The event notification messages may include push notification messages. As noted above, presence-awareness is, in some cases, required to provide push functionality. It has been found that the data channel of the present invention may be advantageously utilised to both communicate presence information, and as a receiving channel for notification messages associated with push functionality.

Typically, the data channel is maintained in an open state by the periodic transmission of predetermined data over the channel to the server. In preferred embodiments, the data is a single byte, transmitted to the server every few minutes.

Preferably, the data channel is implemented in the software product as a separate thread.

Optionally, the software product is in the form of a Java MIDlet.

Typically, the software product includes instructions for monitoring the data connection, and for re-establishing the connection in the event of closure of the connection.

Optionally, the monitoring instructions are implemented as a separate thread.

According to a second aspect of the present invention there is provided a computer software product adapted for execution on an Internet-connected server, the software product including:
instructions for accepting data channel requests from, and establishing a data channel with, one or more wireless devices executing the software product according to a first aspect of the invention;
instructions for receiving event notification messages from a presence-aware application; and
instructions for forwarding the event notification message to the wireless device over the data channel.

The data channels are typically implemented as TCP/IP socket connections, and in preferred embodiments are non-blocking socket connections. Such an implementation overcomes the limitation of blocking socket connections, which would require each channel to be processed by a single thread. Current server operating systems limit the number of threads that may run in a single process to a few hundred, which is clearly not adequate to service the numbers of simultaneous users of presence-aware applications, such as instant messaging, which can be in the millions.

Preferably, the accepting instructions:
establish the data channel on a Socket Multiplexer Server;
associate the established data channel with an identifier included with the connection request; and
return information to the wireless device sufficient to enable the device to identify and use the established channel on the Socket Multiplexer Server.

Additional Socket Multiplexer Servers may be brought online as and when required depending on the number of independent channels being serviced, thereby providing an inherently scalable solution.

In preferred embodiments, the software product includes instructions for querying a database using a device identifier included in notification messages from presence-aware applications, for details of the data channel established on the Socket Multiplexer for the device identified by the device identifier, the data channel details being used by the forwarding instructions to forward the notification message to the identified device.

Optionally, the software product includes instructions for storing device identifiers included in notification messages in association with details of the data channel established on the Socket Multiplexer for device identified by the device identifier, the stored device identifier to be used in processing future notification messages directed to the device identified by the device identifier.

### BRIEF DESCRIPTION OF THE DRAWINGS

An embodiment of the present invention will now be described with reference to the drawings wherein:

FIG. 1 is a block diagram illustrating a suitable network architecture over which the present invention may be implemented; and

FIG. 2 is a data flow diagram illustrating the communications and event sequences of the components of the network architecture illustrated in FIG. 1.

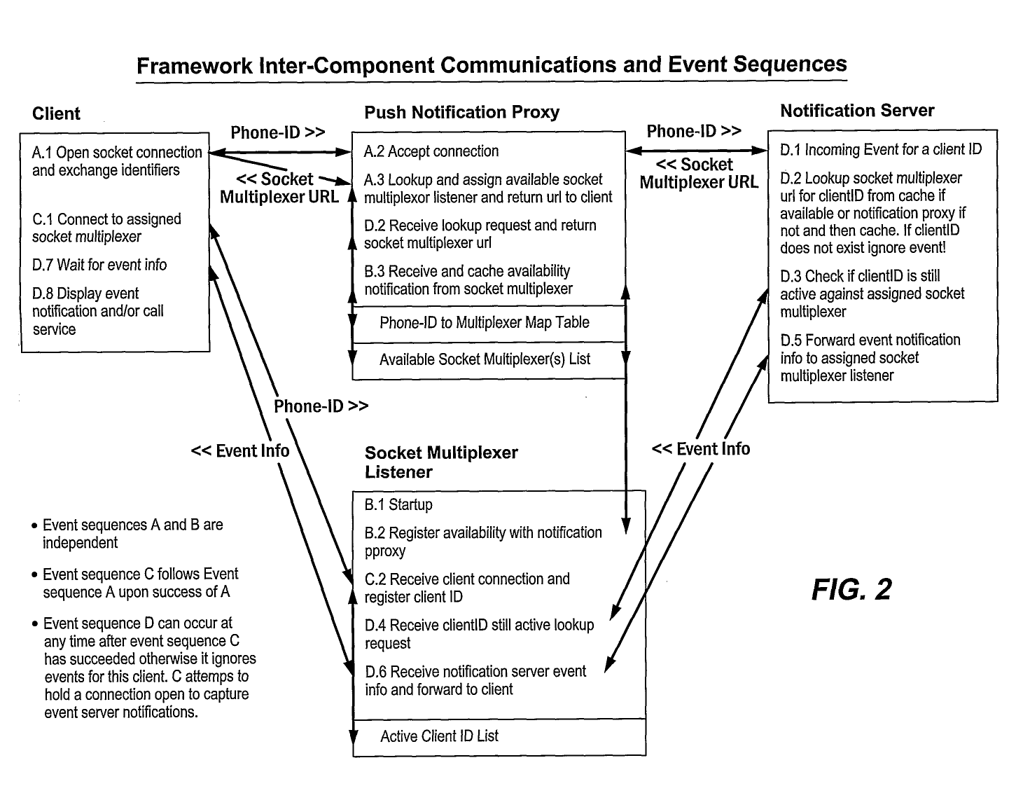

### DETAILED DESCRIPTION OF THE DRAWINGS

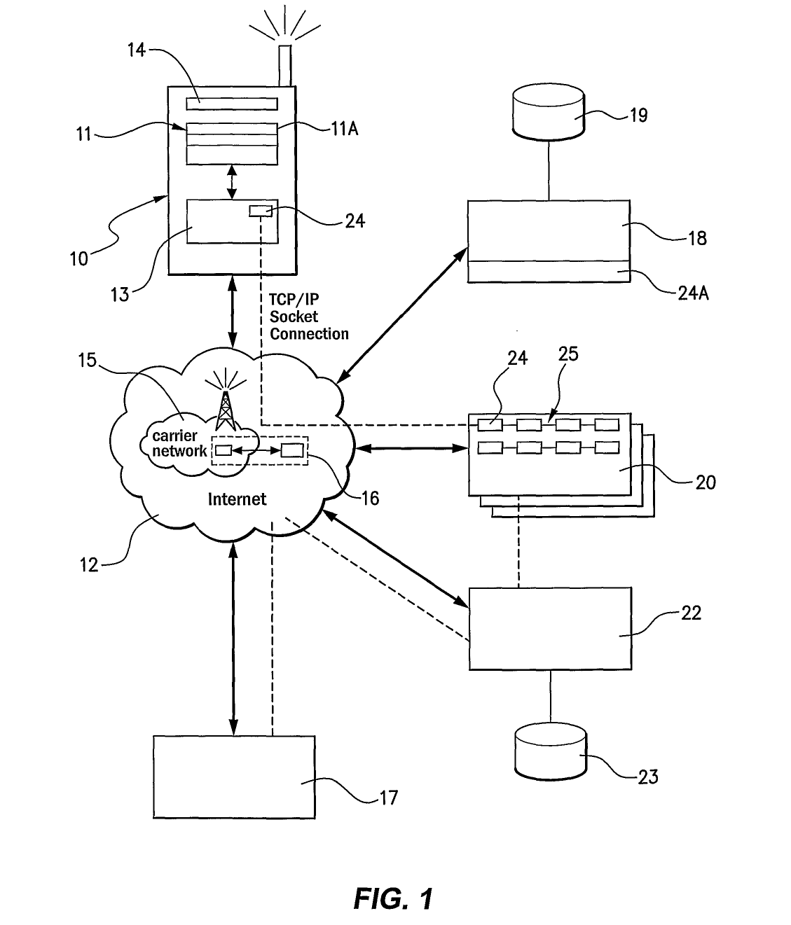

Referring to FIG. 1, a wireless device 10, such as a mobile phone or personal data assistant is illustrated. A suitable operating system is installed on the device upon which application software, in the form of a Java MIDlet 11, executes. The particular implementation of the application software as a Java MIDlet is not essential, and could equally be provided as Java applet or xlet, or as a stand-alone C/C++ application, or similar.

The MIDlet 11 connects the device 10 to the Internet 12 by utilising the services of a Network Protocol Stack 13, which, as understood by those skilled in the art, is provided by the operating system.

A general purpose Internet browser 14 is also installed on the wireless device 10, enabling the device 10 to access web sites, as well other Internet-accessible services such as a presence-aware application 17.

The wireless device 10 is connected to a carrier network 15 that is operated by the device user's telecommunications provider. The carrier network 15 provides the device 10 with typical voice and SMS functionality. Internet data necessarily passes through the carrier network 15 as communications are exchanged between the wireless device 10 and Internet servers such as presence-aware application 17.

However, as far as the client (i.e the browser 14 and/or MIDlet 11) and server (i.e the presence-aware application 17) are aware, only general Internet traffic is being exchanged between the two. The connection between the client and server can therefore be considered as independent of the carrier network 15.

Carrier-independence is illustrated in FIG. 1 by the position of the carrier network 15 as wholly contained within the Internet 12. On the wireless device/client gateway to the carrier network 15, the device/client sees a familiar TCP/IP or UDP/IP protocol stack 13, allowing applications to create and process socket and HTTP connections 24. As known to those skilled in the art, carrier network 15 and device 10 manufacturers implement the low-level transport layers of the Protocol Stack 13 to provide data packet carriage over the carrier network.

An Internet gateway 16 is provided within the carrier network 15 to route data packets between the Internet 12 and carrier network 15, however the gateway 16 is not ‘seen’ by the wireless device/client.

Presence-awareness is implemented on the wireless device 10 by a Push Notification Proxy 18, a Socket Multiplexer Listener 20 and a Notification Server 22.

In order to indicate presence of the wireless device 10, the Java MIDlet 11 seeks to open a semi-permanent data channel 24 (in the form of a TCP/IP socket connection) by utilising the Protocol Stack 13. Once the data channel 24 is established, the wireless device 10 has effectively indicated its presence, and can receive notification messages from presence-aware applications over the channel, the messages providing notifications for incoming emails, messaging services, news feeds, stock quotes etc.

The data channel connection request is made to the Push Notification Proxy 18, which allocates an available Socket Multiplexer Listener 20 (see below) to service the connection, and returns a URL to the wireless device 10, that identifies to the device 10 where the connection 24 can be accessed.

Once open, the socket connection is maintained by a Watchdog thread 11A running on the wireless device 10, that sends a single-byte KEEP ALIVE message over the data channel 24, every three to five minutes to the Socket Multiplexer Listener 20. In the event that the KEEP ALIVE message is not successfully delivered, the device interrupts and kills the thread on which the socket connection 24 is made. After pausing for an appropriate time (such as ten seconds) the wireless device 10 creates a new message notification thread and establishes a new socket connection with the Socket Multiplexer Listener 20.

This functionality can also be described by reference to the following pseudo code:

Client application main thread

Create the message notification thread
Wait a few seconds
Create the notification watchdog thread
Provide place-holder methods so the watch-dog can recreate a
message notification thread and get a handle on the instantiated
message notification class

The functionality of the Watchdog thread 11A may be more particularly described by reference to the following pseudo-code:

Notification watchdog thread

```
while (true) {
  Get socket connection handle if (connection is valid) {
  set alive = true
  while (alive) {
  Write a keep-alive byte to socket multiplexer listener every 3-5 minutes
  On failure/exception: Break the loop, set alive = false;
  }
  Interrupt and kill message notification thread
  Sleep for 10 seconds
  Re-create Message Notification Thread
```

As discussed above, the socket connection is between the wireless device 10 and a Socket Multiplexer Listener 20, whereas the initial connection request is made by the wireless device to the Push Notification Proxy 18, which in turn allocates a connection on the Socket Multiplexer Listener 20. The Socket Multiplexer Listener 20 processes many thousand socket connections simultaneously, and does so by providing non-blocking multiplexed server socket connections.

Non-blocking socket connections use a minimal number of processing threads to handle a large number of individual connections. Such processes do not require a separate processing thread for each connection and do not block on each connection waiting for activity. In particular, a connection thread implements multiple connections within a pipeline structure 25 on the Socket Multiplexer Listener 20. An activity thread 24A stores information relevant to the connections, and processes the connections 24 in the manner described below.

Upon creation, the activity thread 24A assigns each data channel 24 with an activity status and state, to indicate that the data channel is active. The activity thread 24A returns a list of all entries in the pipeline that are active.

The activity thread 24 runs continuously in a tight loop, requesting the active connections list and sequentially processing the data channels 24 in the list. The entries in the list indicate one of the following states:
new connection;
read; or
write

The activity thread 24A processes the data channels 24 by either:
adding references relevant to new connections to an internal table based upon a common key (namely the international phone number) for reference by notification threads 11 running on wireless devices;
reading bytes sent from the wireless device; or
writing bytes to the wireless device.

In a read state, the relevant identifier for the wireless device 10 (see below) and socket connection handler associated with that identifier may be obtained. Keepalive bytes (see above) for the device may also be processed when the connection is an a read state.

In the write state bytes are forwarded to the wireless device over the connection 24 for interpretation by the application 11. Typically this information consists of a header to indicate the type of alert, a count, or optionally a length and accompanying message bytes (see below).

The Socket Multiplexer Listener 20 is a non-blocking multiplexed server because it does not require a separate processing thread for each connection, and does not block on each connection waiting for activity. A key advantage of non-blocking servers is their ability to effectively decouple the number of processing threads from the number of connections requiring processing. In contrast, blocking servers require each client-to-server connection to be processed by a separate thread. As understood by those skilled in the art, there are physical limits as to how many threads can execute within a single process, with the upper limit typically being in the hundreds of threads per process.

However, notwithstanding the processing efficiencies obtained through the use of non-blocking server connections, server CPU speeds will eventually limit the number of connections that can be serviced, typically to the tens of thousands. To overcome this, any number of Socket Multiplexer Listeners 20 can be activated on separate commuting platforms, to address demand. New Socket Multiplexer Listeners 20 are brought online by registering with the Push Notification Proxy 28.

The Push Notification Proxy 18, provides a number of services in this context:
1. Wireless device 10 to Socket Multiplexer Listener 20 broker. This decides which device 10 communicates with which Socket Multiplexer Listener 20.
2. Notification Server to Socket Multiplexer Listener, broker. Upon arrival of an event (see below) in the Notification Server 22, tagged to a particular device, the Push Notification Proxy looks up whether that device is currently registered and returns the Socket Multiplexer Listener assigned to that device.
3. Load balancing across Socket Multiplexer Listeners. This can be based on a progressive fill, or round robin algorithm
4. Scalability. Many Socket Multiplexer Listeners can be brought online to meet the demand of an ever increasing number of clients. Each of these Socket Multiplexer Listeners run on separate computing platforms; and
5. Reporting and Analysis. This is used for engineering capacity planning to determine if more Socket Multiplexer Listeners need to be brought online.

Placing the Push Notification Proxy 18 in front of the Socket Multiplexer Listeners 20, and having the Push Notification Proxy 18, act as an arbiter between a device 10 and many independent Socket Multiplexer Listeners, increases the scalability of the framework by several orders of magnitude. Once the system expands into servicing tens of millions of simultaneous clients, the Push Notification Proxy itself may require duplication. In this case, intelligent routers, route requests from different sources to different Push Notification Proxies based upon load, availability or geography. The Push Notification Proxies record their Socket Multiplexer assignments in a data store that is accessible by all Proxy Servers.

Once the socket connection 24 is opened between the wireless device 10 and Socket Multiplexer Listener 20, the wireless device has indicated its presence and can participate in a presence-aware application 17. The presence aware application communicates with the wireless device 10 by sending notification messages to the Notification Server 22 that provide notifications for incoming emails, messaging services, news feeds, stock quotes etc. The notification messages include a unique identifier (i.e the international phone number) for the device to which the message is directed.

The Notification Server 22 is either embedded within the Socket Multiplexer Listener 20 as a series of separate threads, or may be implemented as a separate process that communicates with the Socket Multiplexer Listener 20 via a socket connection, and passes identification credentials in the message. The Socket Multiplexer Listener 20 retrieves the message and identification details, and forwards information to the MIDlet 11 via the socket connection 24.

When the Notification Server 22 receives an incoming message, it firstly queries the Socket Multiplexer Listener 20 for the URL of the socket connection 24 of the identified device 10 and performs a lookup of an associated client connection handler. If the unique identifier is valid, and is still active against the assigned Socket Multiplexer Listener 20, the notification message is forwarded to the assigned Socket Multiplexer Listener 20.

The socket multiplexer URL for a particular client ID is retrieved from cache memory 23 at the Notification Server 22, if available.

Socket Multiplexer Listener 20 forwards the message to the wireless device over the socket connection 24, which the device 10 receives and acts accordingly. The above functionality can also be described by way of the following pseudo code

Message Notification Thread

```
alive = true
while (alive) {
  Connect to the notification proxy to retrieve assigned socket multiplexer
  listener
  if (connection is valid) {
  Connect to assigned socket multiplexer listener passing clientID
  if (connection is valid) {
  Wait for multiplexer listener event notifications and display event
  information
  }
  }
  if (InterruptedException or any Exception occurs) {
  alive = false
  exit run method of thread and allow watchdog thread to cleanup this
  thread
}
```

Notifications messages forwarded to wireless devices 10 are typically only a few bytes in length and include the following information:
Event Type-1 byte
Number of such events or the size of an accompanying message-1 byte
Accompanying Message-N Bytes

Upon receipt of the notification message, the device 10 simply displays the event type and number of such events, or issues a server-side HTTP request, in the event that a notification service request is attached to the current display, and the device is operating within an active HTTP session.

The purpose of such notification messages is to alert users currently not in-session (i.e. not logged into the presence-aware application 17) that events are occurring that they may wish to investigate at their discretion. Alternatively, notification messages pro-actively update the display of in-session users who are currently viewing event-sensitive displays. Such displays have an event-notification service attached, and when a relevant notification message arrives, an HTTP service is called and the display is updated with user initiation.

Event notifications are also used to notify that a new email has arrived, and/or to call an appropriate service such as Instant Messenger Client.

It will be realised by those skilled in the art that the method and system described above provides a low-bandwidth channel for communicating presence information from a mobile device to a highly scalable presence detection server framework, thereby enabling notifications to be sent to the mobile device at any time.

Moreover, the mobile device maintains a separate communications channel, sending only a minimal amount of data in order to keep the channel alive (approx. 1 byte per 3 minutes). If the connection is terminated for any reason, the device initiates a reconnection in a separate thread to a server-side push notification proxy, which in turn issues a specific socket multiplexer with which it will maintain a long-term connection.

Provided the device is genuinely available (i.e not switched off or the relevant application exited) event notifications can be sent to the device via an event notification server communicating back through the socket multiplexor at any time. Using the method and system according to the present invention, the existence of a communications channel between the client and socket multiplexor means the device is genuinely present. This information is stored in the proxy server either in memory (and can be persisted to a database) available for lookup via a request to the proxy server.

Modifications and improvements to the invention will be readily apparent to those skilled in the art. Such modifications and improvements are intended to be within the scope of this invention.

The word ‘comprising’ and forms of the word ‘comprising’ as used in this description and in the claims do not limit the invention claimed to exclude any variants or additions. Modifications and improvements to the invention will be readily apparent to those skilled in the art. Such modifications and improvements are intended to be within the scope of this invention.

1. A computer software product adapted for execution on a wireless device in communication with a carrier network, the software product comprising:
instructions for establishing a data channel by opening a non-blocking connection on an Internet-based server independently of the carrier network; and
instructions for maintaining the data channel in an open state, wherein the data channel indicates presence in a presence-aware application.

2. The computer software product according to claim 1, wherein the data channel is configured to enable event notification messages associated with the presence-aware application to be delivered to the wireless device.

3. The computer software product according to claim 2, wherein the event notification messages include push notification messages.

4. The computer software product according to claim 1, further comprising instructions for maintaining the data channel in an open state by periodically transmitting predetermined data over the data channel to the server.

5. The computer software product according to claim 4, wherein the predetermined data is a single byte, transmitted to the server every few minutes.

6. The computer software product according to claim 1, wherein the data channel is implemented in the software product as a separate thread.

7. The computer software product according to claim 1, further comprising instructions for monitoring the data connection, and for re-establishing the connection in the event of closure of the connection.

8. The computer software product according to claim 7, wherein the monitoring instructions are implemented as a separate thread.

9. A computer software product adapted for execution on an Internet-connected server, the software product comprising:
instructions for accepting data channel requests from, and opening a non-blocking connection to establish a data channel with, one or more wireless devices, wherein the one or more wireless devices execute
instructions for establishing the data channel by opening the non-blocking connection on the Internet-based server independently of a carrier network; and
instructions for maintaining the data channel in an open state, wherein the data channel indicates presence in a presence-aware application;
instructions for receiving event notification messages from the presence-aware application; and
instructions for forwarding the event notification message to the wireless device over the data channel.

10. The computer software product according claim 9, wherein the accepting instructions are configured to:
establish the data channel on a Socket Multiplexer Server;
associate the established data channel with an identifier included with the data channel request; and
return information to the wireless device sufficient to enable the device to identify and use the established channel on the Socket Multiplexer Server.

11. The computer software product according to claim 10, wherein the accepting instructions are implemented on a Push Notification Proxy.

12. The computer software product according to claim 10, wherein the data channels are established on the Socket Multiplexer Server within a pipeline structure.

13. The computer software product according to claim 10, further comprising an activity thread configured to store information relevant to the established data channels and to process the established data channels.

14. The computer software product according to claim 13, wherein the data channels are established on the Socket Multiplexer Server within a pipeline structure, and wherein the activity thread is configured to sequentially process each connection in the pipeline structure.

15. The computer software product according to claim 10, further comprising instructions for querying a database using a device identifier included in event notification messages from the presence-aware application, for details of the data channel established on the Socket Multiplexer Server for the device identified by the device identifier, the data channel details being used by the forwarding instructions to forward the event notification message to the identified device.

16. The computer software product according to claim 10, further comprising instructions for storing device identifiers included in event notification messages from the presence aware application in association with details of the data channel established on the Socket Multiplexer server for the device identified by the device identifier, the stored device identifier to be used in processing future notification messages directed to the device identified by the device identifier.

17. A wireless data communication system comprising:
two or more wireless devices upon which a wireless device computer software product is installed, wherein the wireless device computer software product comprises:
instructions for establishing a data channel by opening a non-blocking connection on an Internet-based server independently of the carrier network; and
instructions for maintaining the data channel in an open state, wherein the data channel indicates presence in a presence-aware application; and
a server upon which a server computer software product is installed, wherein the server software product comprises:
instructions for accepting data channel requests from, and opening a non-blocking connection to establish a data channel with, the two or more wireless devices,
instructions for receiving event notification messages from the presence-aware application; and
instructions for forwarding the event notification message to the wireless device over the data channel.

18. The wireless data communication system according to claim 17, further including a Notification Server configured to receive notification messages from presence aware applications, and to forward the messages to the server for transmission to a wireless device via the data channel.

19. The wireless data communications system according to either one of claim 17, further comprising one or more additional servers upon which a separate Socket Multiplexer Server is installed.
